(19) United States
(12) Patent Application Publication
(10) Pub. No.: US 2016/0158665 A1
(43) Pub. Date: Jun. 9, 2016

(54) FLOATING SALT FARM

(71) Applicant: JAE HYUN LIM, CRESSKILL, NJ (US)

(72) Inventor: JAE HYUN LIM, CRESSKILL, NJ (US)

(21) Appl. No.: 15/045,981

(22) Filed: Feb. 17, 2016

(51) Int. Cl. B01D 1/00; B63B 35/00; B63B 39/02; C01D 3/06

(52) U.S. Cl. CPC B01D 1/0005; C01D 3/06; B63B 35/00; B63B 39/02

(57) ABSTRACT

The proposed system, floating salt farm, is for producing crystallized salt and bittern by using extracted seawater affected by volcanic eruption activities originating from erupted underwater volcanic vents, and in which the extracted seawater contains amounts of specific chemical elements. The proposed system further comprises a farm facility which includes a refinery and a treatment facility, which are both used for further processes including the process of extracting specific chemical elements from produced crystallized salt and bittern which contain amounts of highly concentrated and specific chemical elements.

### CROSS-REFERENCE TO RELATED APPLICATIONS

This present Application is a continuation-in-part of U.S. Pat. No. 9,181,102, issued on Nov. 10, 2015, and is claiming the benefits of U.S. Pat. No. 8,894,810, issued on Nov. 25, 2014, U.S. Provisional Patent Application No. 62/280,847, filed on Jan. 20, 2016, and U.S. Provisional Patent Application No. 62/186,175, filed on Jun. 29, 2015. The entire disclosures of all these Patents and Patent Applications are incorporated herein by reference.

### BACKGROUND OF THE INVENTION

A floating salt farm is a system which is capable of running reliably and regularly to produce substantial amounts of crystallized salt and bittern through evaporation by using extracted seawater.

The proposed system can mass produce crystallized salt and bittern.

The seawater is extracted at a specific offshore location where the seawater is affected by underwater volcanic eruption activities and contains amounts of specific chemical elements.

The produced crystallized salt and bittern are the final products for the present invention, floating salt farm, in which the produced crystallized salt and bittern contain highly concentrated and specific chemical elements.

The proposed system further comprises of a farm facility used for further processes, including the process of extracting specific chemical elements from produced crystallized salt and bittern through well-established chemical technologies.

The proposed system's processes which include processes to extract chemical elements from produced crystallized salt and bittern, has a lower environmental impact than traditional mining processes.

### BRIEF SUMMARY OF THE INVENTION

The present invention, the floating salt farm, is a system situated at a specific offshore location for producing crystallized salt and bittern through evaporation by using extracted seawater.

The extracted seawater which contains amounts of specific chemical elements, is affected by volcanic eruption activities originating from erupted underwater volcanic vents.

The components which are used for the proposed system, are fixed on the buoyant foundation.

The buoyant foundation is reinforced with a mooring line structure, which is embedded to the seafloor, and the buoyant foundation is also reinforced with a combination of an offshore structure and a mooring line structure which are both connected to the buoyant foundation.

The components which are used for the proposed system, can consist of a seawater tank, an evaporator tank, and a plurality of photovoltaic panels.

The seawater tank is used for extracting seawater affected by volcanic eruption activities at a specific offshore location.

The evaporator tank is used for evaporating the seawater and producing crystallized salt and bittern.

A plurality of photovoltaic panels which is used for supplying electricity, comprises of electricity storage tanks mounted on the buoyant foundation which are used for accumulating electricity.

The proposed system has a farm facility which comprises of a refinery and a treatment facility, which are both used for further processes including the process of extracting specific chemical elements from produced crystallized salt and bittern, in which contain amounts of highly concentrated and specific chemical elements.

The farm facility which is fixed on a station terminal, can be mounted on an island station terminal or a floating station terminal.

A station terminal which is equipped with a farm facility, comprises of an energy source facility and a drone platform facility which are both used for the proposed system.

### BRIEF DESCRIPTION OF DRAWINGS

FIG. 1A is a top view of an embodiment of a floating salt farm.

FIG. 1B illustrates an embodiment of a floating salt farm with a combination of an offshore structure and mooring lines embedded to sea floor.

FIG. 2 is a top view of an arrangement of components of a floating salt farm.

FIG. 3 is a side view of a buoyant foundation equipped with components of a floating salt farm.

FIGS. 4A and 4B are side views of a buoyant foundation fixed to a ballast tank.

FIG. 5 is a side view of an extraction pipe component with a sea drone.

FIG. 6 is a side view of floating salt farms.

FIG. 7 is a top view of a floating salt farm.

FIG. 8A is a side view of a floating salt farm.

FIG. 8B is a top view of a barge.

FIG. 9A is a top view of a floating salt farm.

FIG. 9B is a top view of photovoltaic panels fixed on a buoyant foundation.

FIG. 10A is a side view of a floating salt farm.

FIG. 10B is a top view of a floating salt farm.

FIG. 11A is a top view of a seawater extraction vessel.

FIG. 11B is a side view of a seawater extraction vessel.

FIG. 12 is a side view of an evaporator tank.

FIGS. 13A and 13B are top views of floating salt farms.

FIG. 14A is a side view of a repair vessel.

FIG. 14B is a side view of a floating breakwater.

FIG. 15 is a top view of an island station terminal.

FIG. 16 is a top view of a floating station terminal.

FIG. 17 is a top view of a station terminal.

### DETAILED DESCRIPTION OF THE INVENTION

Detailed embodiments of the invention can be illustrated using the accompanying drawings as reference.

A floating salt farm is a system situated at a specific offshore location for producing crystallized salt and bittern through evaporation by using extracted seawater which is affected by underwater volcanic eruption activities and contains amounts of specific chemical elements.

The proposed system is used for producing crystallized salt and bittern, which contain amounts of highly concentrated and specific chemical elements.

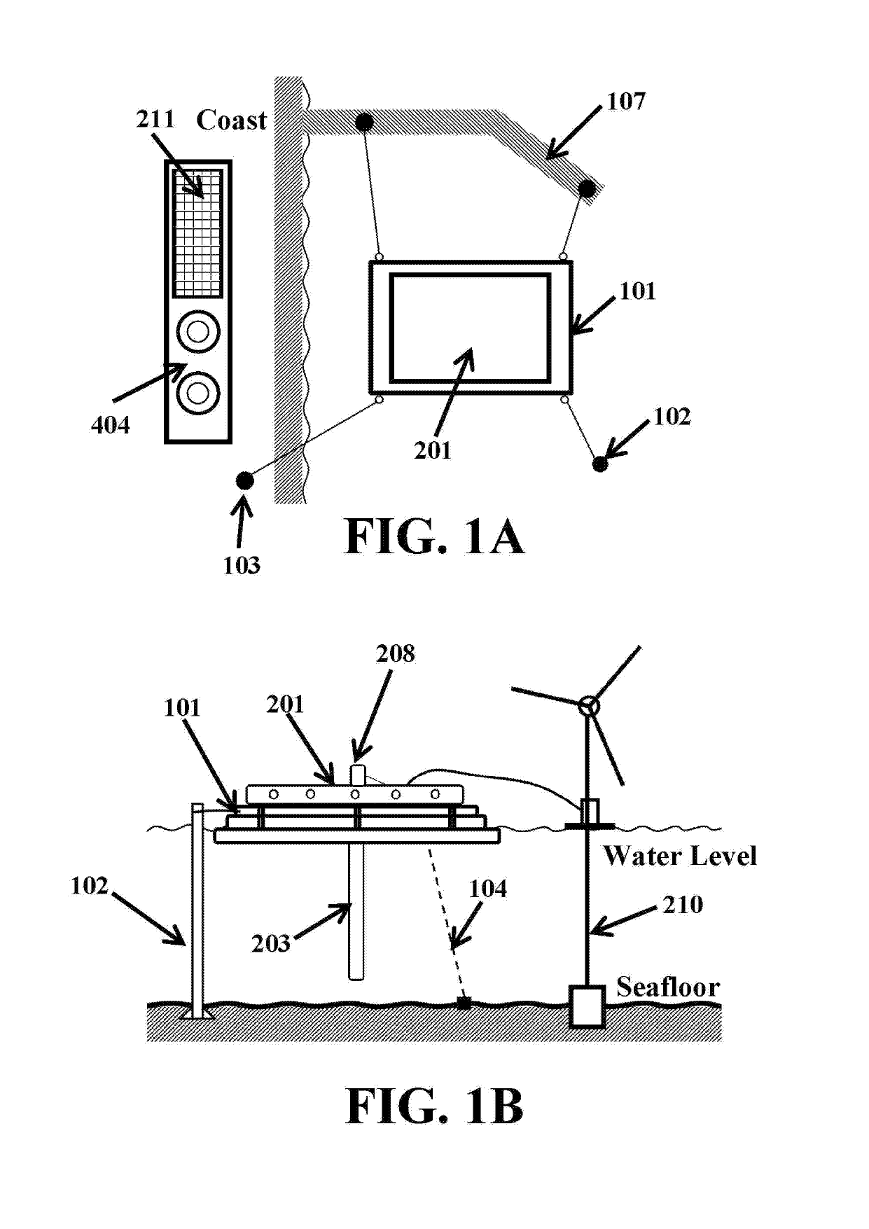

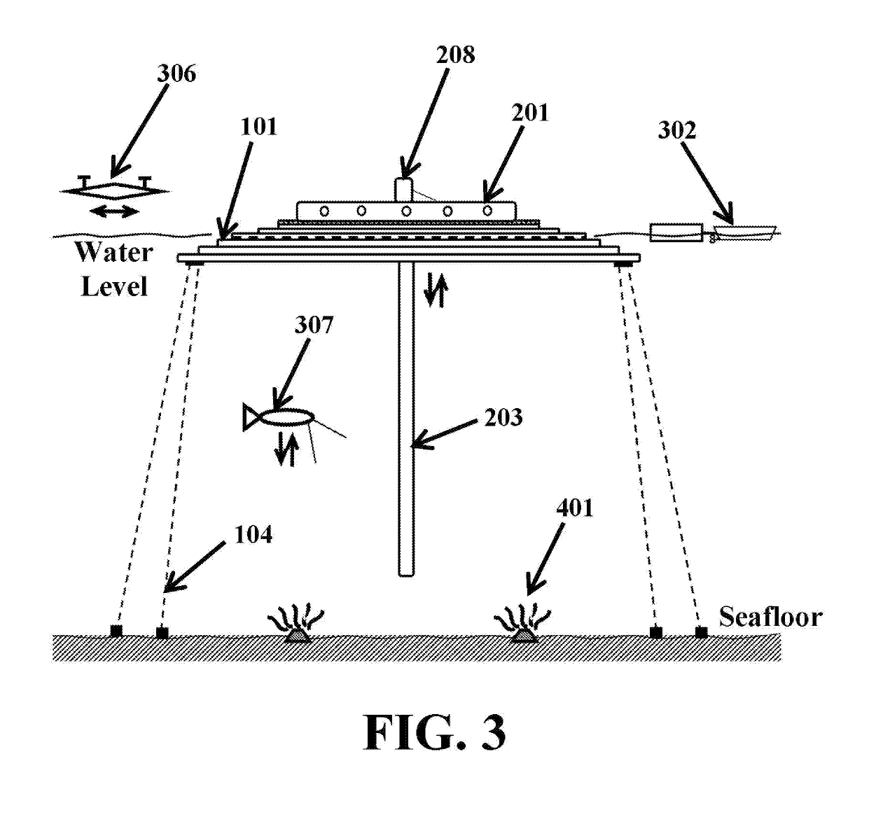

In the embodiment shown in FIG. 1A, the buoyant foundation 101 is situated at a specific offshore location, in which the buoyant foundation 101 is reinforced with a combination of an offshore structure 102 and an onshore structure 103. The buoyant foundation 101 is also reinforced with a mooring line structure 104 which is embedded to the seafloor, as shown in FIGS. 3, 8A, and 10A.

In the embodiment shown in FIG. 1B, the buoyant foundation 101 is reinforced with a combination of an offshore structure 102 and a mooring line structure 104 embedded to the seafloor, which are both connected to the buoyant foundation 101.

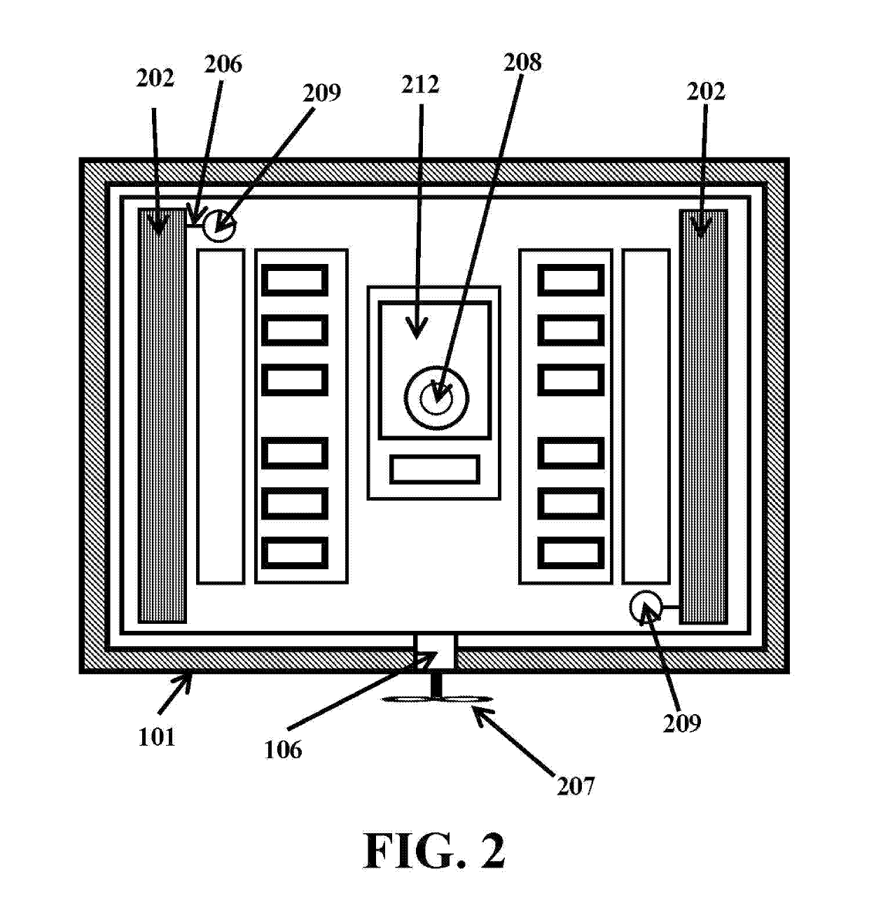

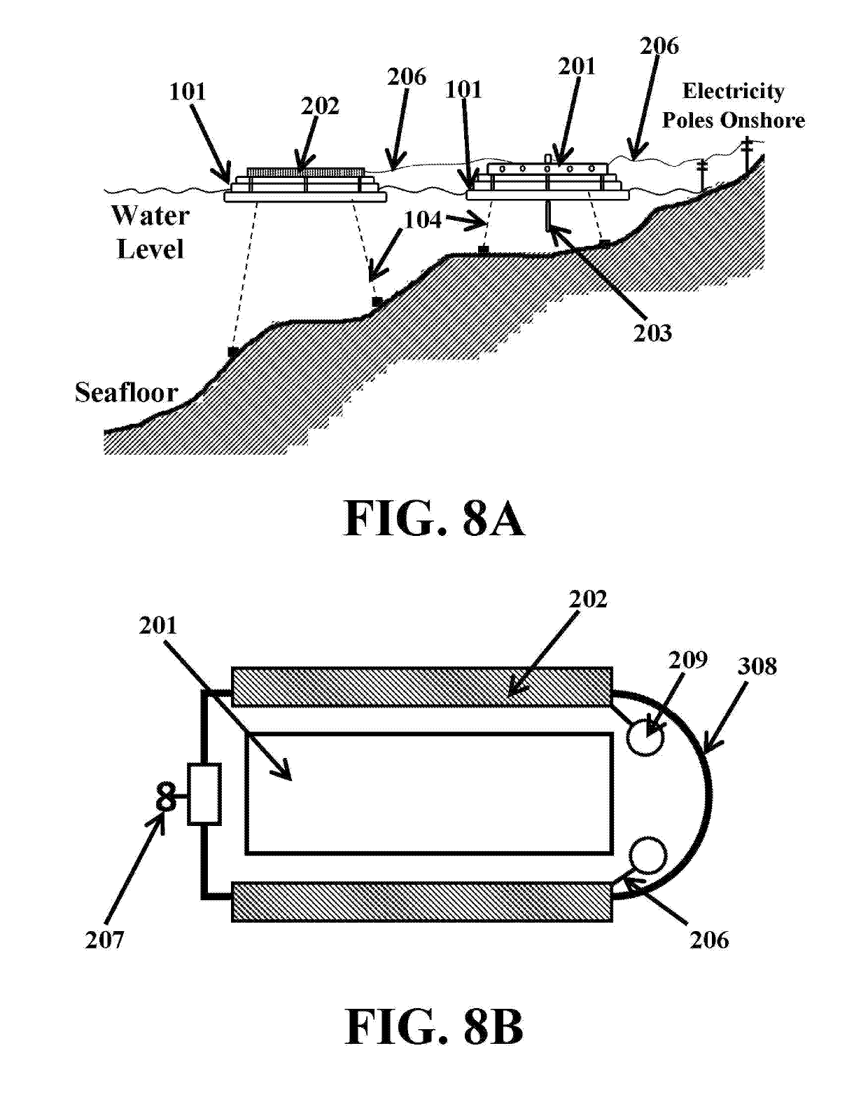

The buoyant foundation 101 is a structural platform situated at a specific offshore location, in which the buoyant foundation 101 is (a) a movable structure which is equipped with components 201 for the floating salt farm, as shown in FIGS. 2, 4A, 4B, and 9B, which includes a barge 308 with a motor propeller 207, as shown in FIG. 8B, or (b) a fixed structure which is equipped with components 201 for the floating salt farm, as shown in FIGS. 1A, 1B, 3, 8A, and 10A, which includes a structurally remodeled offshore oil and gas platform which can be used for the floating salt farm.

The offshore oil and gas platform which is used for the buoyant foundation, can be designed to include a semi-submersible foundation which can be reinforced with a mooring line structure 104 embedded to the seafloor, as shown in the embodiment of FIG. 3.

The buoyant foundation 101 comprises of an extraction pipe component 203 for extracting seawater which includes a lifter device 208 used for adjusting the depth of the extraction pipe component 203, as shown in FIGS. 1B, 2, 3, 4A, 4B, 8A, and 10A.

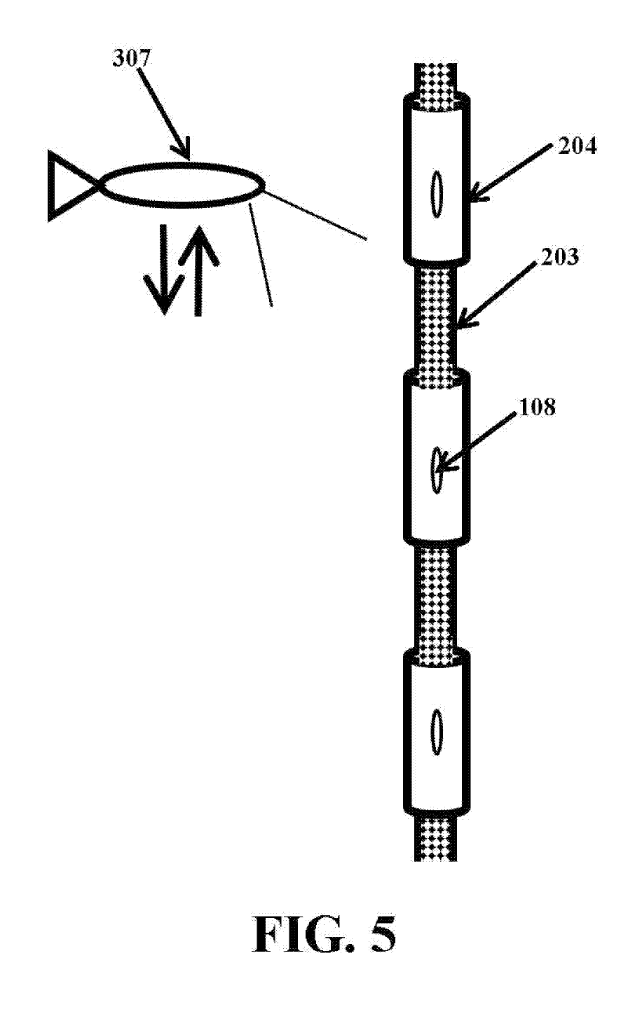

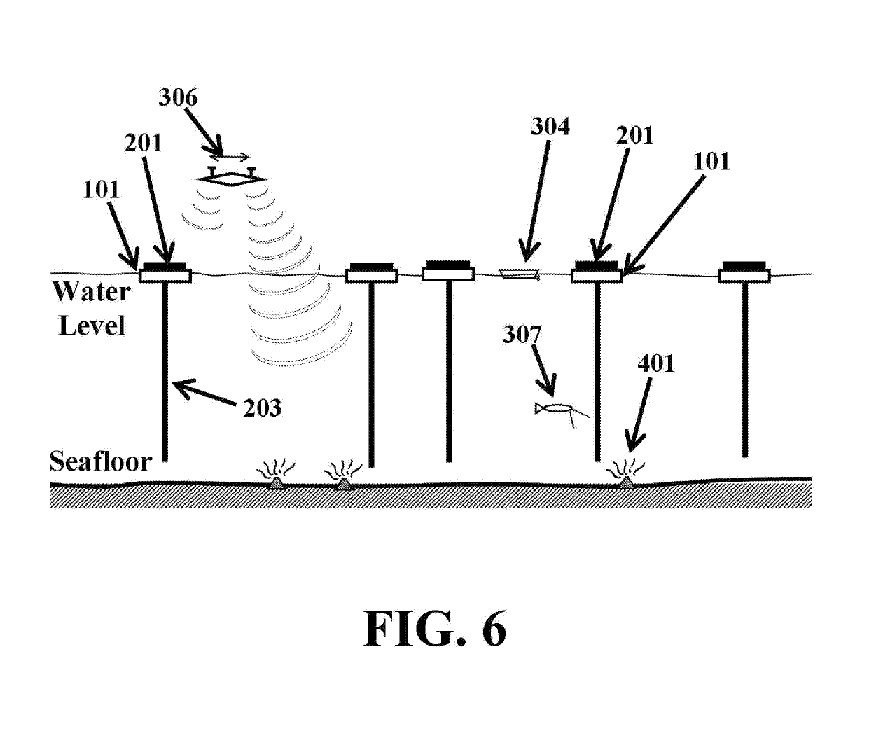

The extraction pipe component 203 can be encased with extracting pipe fittings 204, as shown in FIG. 5. Each extraction pipe fitting 204 can have reflectors 108 which allow aerial drones 306 and sea drones 307 to detect the position of the extraction pipe component 203, as shown in FIGS. 5 and 6.

The proposed system's buoyant foundation 101 also comprises of devices which include an engine 106, aerial drones 306, and sea drones 307. The engine device 106 which is mounted on the buoyant foundation 101, operates the motor propeller 207 installed to the buoyant foundation 101, as shown in FIGS. 2, 4B, and 9B, and is powered by electricity and fuel.

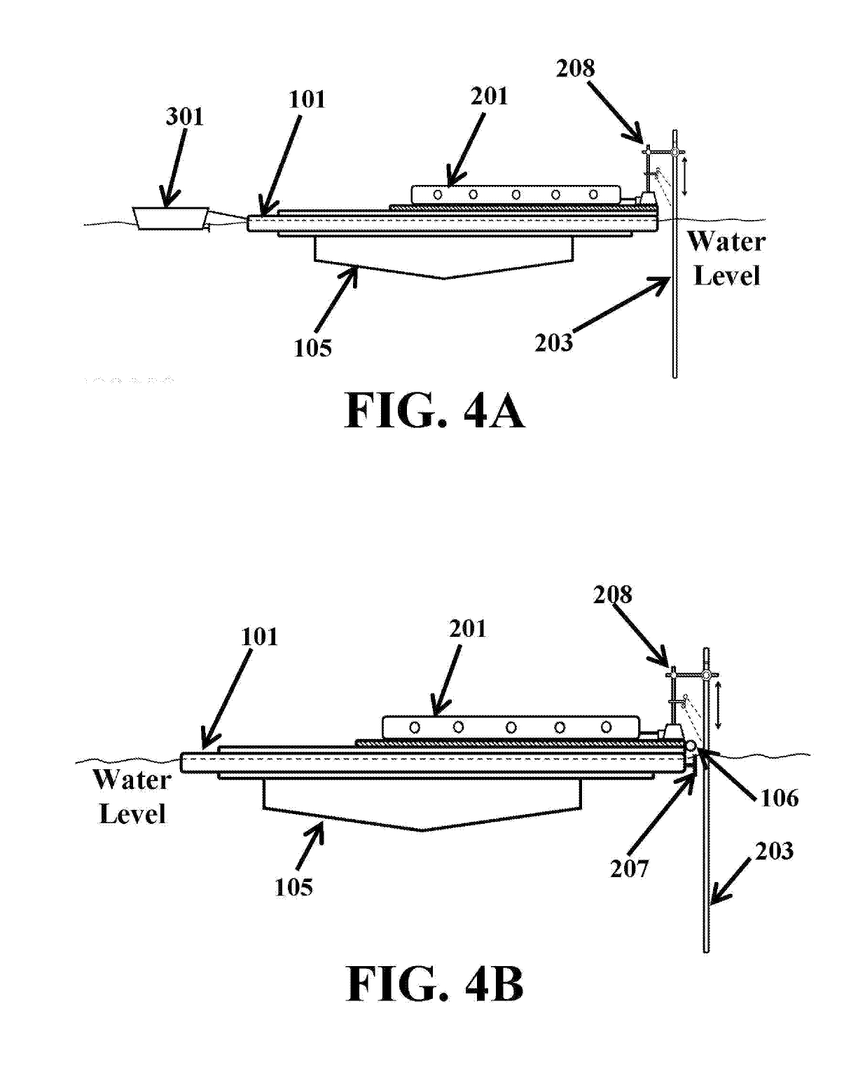

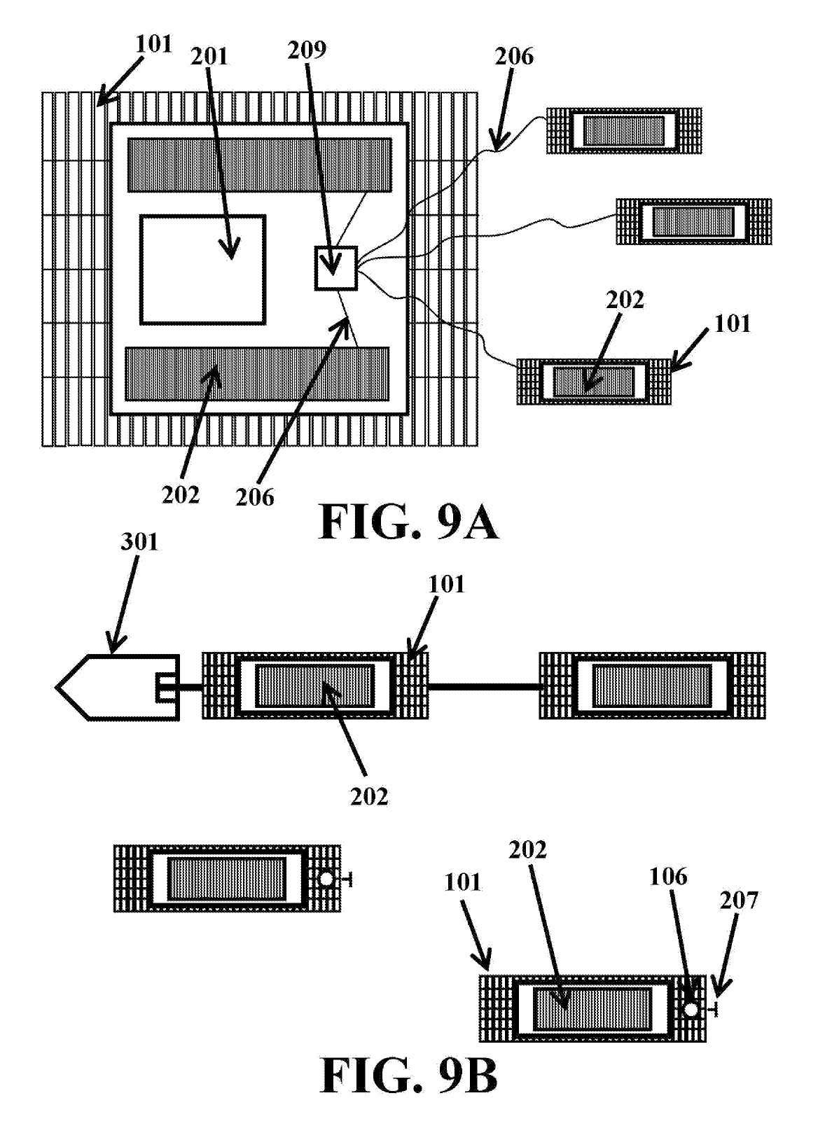

In the embodiments shown in FIGS. 4A and 9B, the buoyant foundation 101 situated at a specific offshore location can also be moved by a towboat 301.

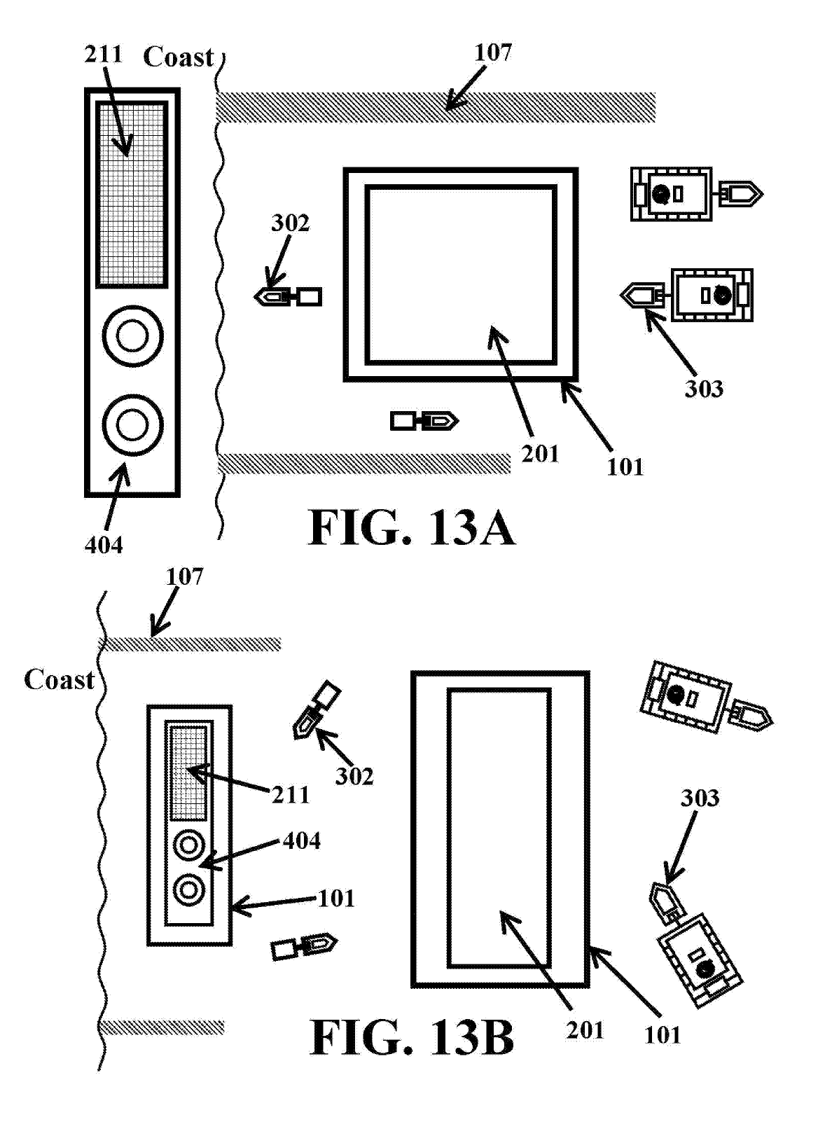

The proposed system's buoyant foundation has devices, including aerial drones 306 and sea drones 307, which are used for patrolling at a specific offshore location around the site of operating floating salt farms. The aerial drones 306 and sea drones 307 can monitor and measure structural and operating conditions of the buoyant foundations 101 and components 201, which are fixed on the buoyant foundation 101, at a specific offshore location, as shown in FIGS. 3, 5, and 6. The aerial drones 306 and sea drones 307 are launched from and controlled by a station terminal 404, as shown in FIGS. 13A, 13B, 15, 16, and 17.

The buoyant foundation 101 can be designed to have a ballast tank 105, as shown in FIGS. 4A and 4B, which can be used for increasing stability for the buoyant foundation 101.

A plurality of photovoltaic panels 202 which is used for the proposed system, comprises of electricity storage tanks 209.

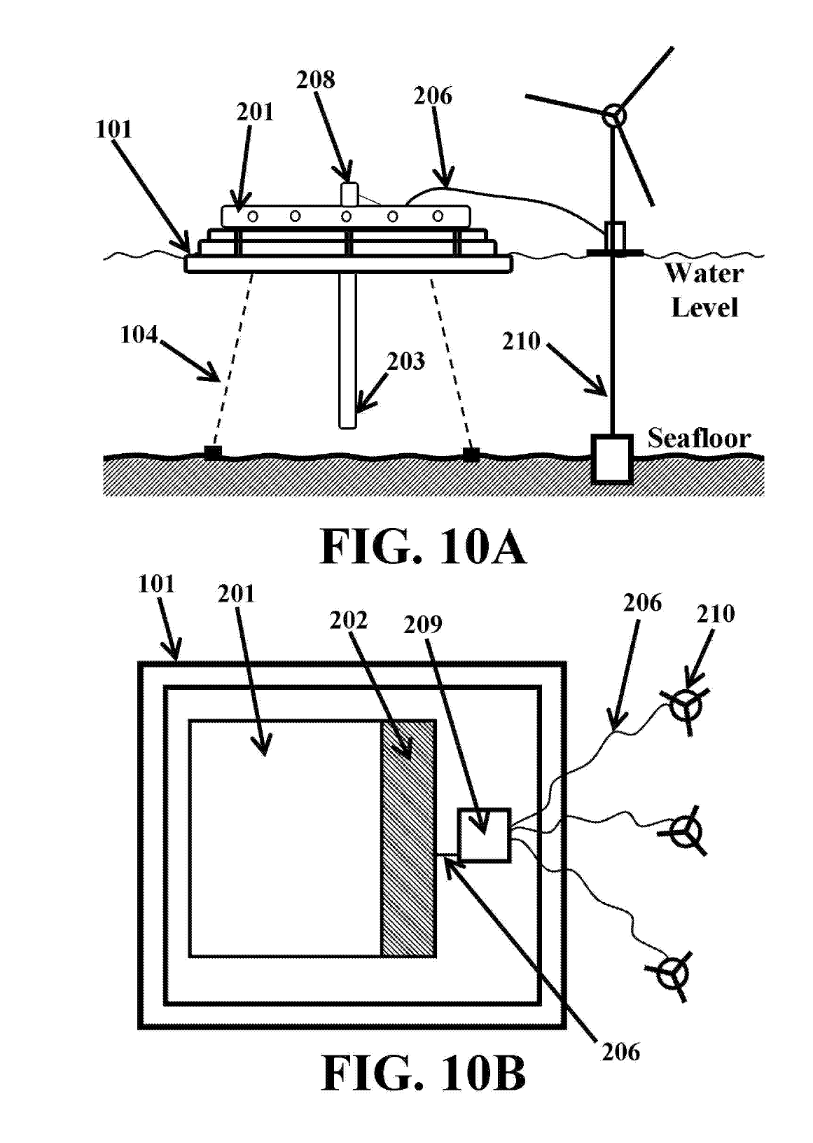

The energy sources which include fuel and electricity, are used for operating the floating salt farm. The electricity which is supplied from electricity storage tanks 209 mounted on the buoyant foundation 101, is supplied from (a) a plurality of photovoltaic panels 202 fixed on the buoyant foundation 101 which is connected to the electricity storage tanks 209 through electric cables 206, as shown in FIGS. 2, 8A, 8B, and 9A, and (b) offshore fixed-bottom wind turbines 210 which are also connected to the electricity storage tanks 209 through electric cables 206, as shown in FIGS. 1B, 10A, and 10B.

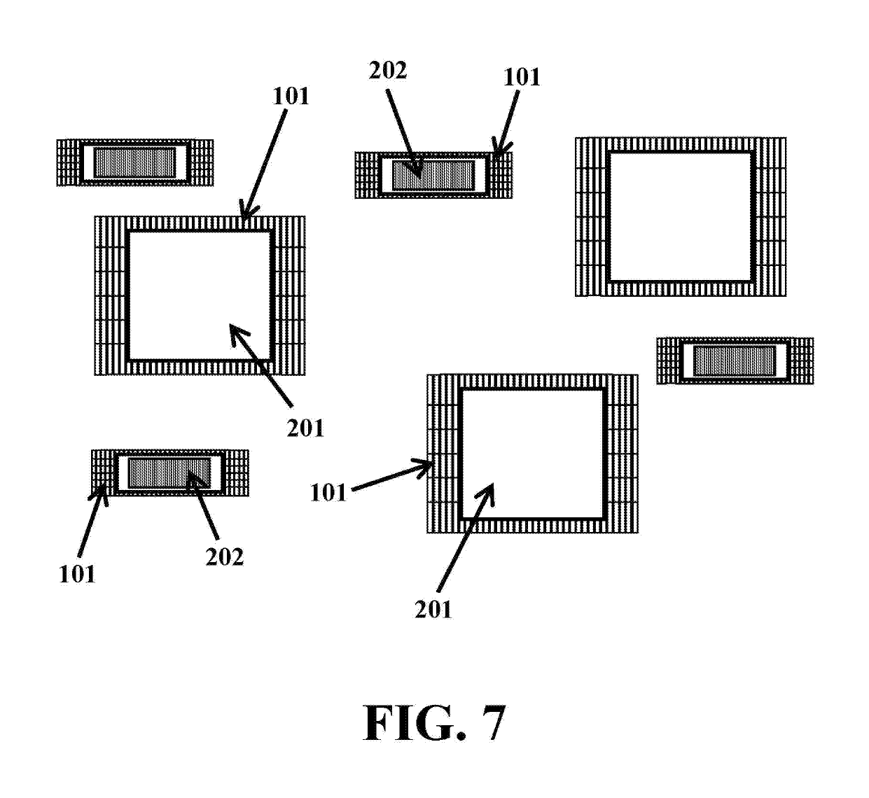

The electricity storage tank 209 is an electricity storage structure which comprises of electric batteries and is used for accumulating electricity supplied from (a) a plurality of photovoltaic panels 202, and (b) offshore fixed-bottom wind turbines 210. The electricity can also be supplied from electricity poles, which are located onshore, through electric cables 206 connected to the floating salt farm, as shown in FIG. 8A. The transport vessels 302 can (a) deliver fuel and electric batteries from a station terminal 404 to the floating salt farm, and (b) deliver electric batteries from the electricity storage tanks 209 mounted on the buoyant foundation 101, back to the station terminal 404, as shown in FIGS. 3, 13A, 13B, 15, 16, and 17. Each buoyant foundation 101 is equipped with a plurality of photovoltaic panels 202 and is situated at a specific offshore location, in which the plurality of photovoltaic panels 202 is used for generating electricity and is connected to electricity storage tanks 209 through electric cables 206, as shown in FIGS. 7 and 9A. In the embodiment shown in FIGS. 2, 8B, and 9A, the plurality of photovoltaic panels 202, which is fixed on a buoyant foundation 101 or a barge 308, is connected to the electricity storage tank 209 through electric cables 206.

In the embodiments shown in FIGS. 3 and 6, the seawater tank 212 which is a component of the floating salt farm, is used for extracting seawater. The seawater tank 212 which is fixed on the buoyant foundation 101, is situated at a specific offshore location around volcanic sites where the extracted seawater is affected by volcanic eruption activities originating from erupted underwater volcanic vents 401. The erupted underwater volcanic vents 401 which release hot vent water, include black smoker vents and white smoker vents. The seawater is extracted at a specific offshore location around volcanic sites and contains amounts of specific chemical elements.

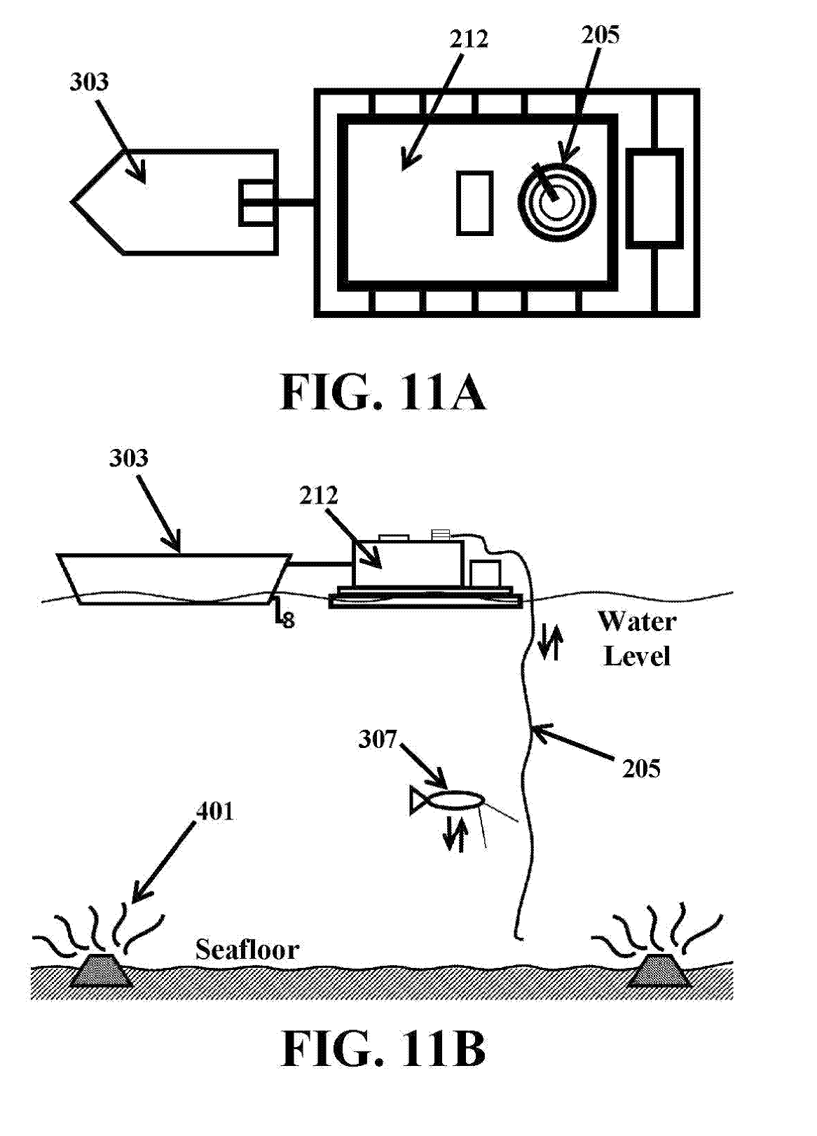

The seawater extraction vessel 303 is connected to a seawater tank 212 attached to a seawater extraction tube 205 which is used for extracting seawater at a specific offshore location around volcanic sites, as shown in FIGS. 11A and 11B, where the extracted seawater is affected by volcanic eruption activities originating from erupted underwater volcanic vents 401, as shown in FIG. 11B. The erupted underwater volcanic vents 401 which release hot vent water, include black smoker vents and white smoker vents. The seawater is extracted at a specific offshore location around volcanic sites and contains amounts of specific chemical elements.

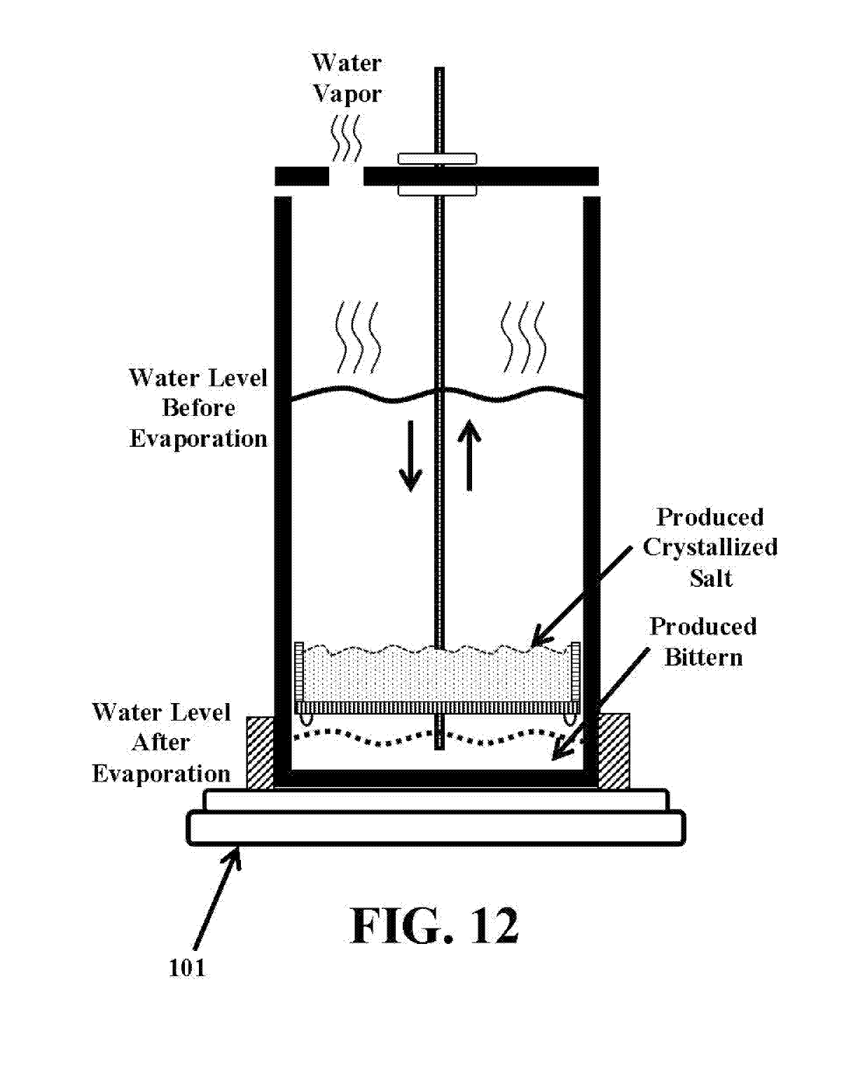

In the embodiment shown in FIG. 12, an evaporator tank which is a component of the floating salt farm and is fixed on the buoyant foundation 101, evaporates the extracted seawater which is affected by volcanic eruption activities. The evaporator tank is used for producing crystallized salt and bittern.

The produced crystallized salt and bittern, as shown in FIG. 12, contain amounts of highly concentrated and specific chemical elements including magnesium, aluminum, calcium, potassium, bromine, silicon, titanium, copper, zinc, selenium, lithium, cerium, neodymium, dysprosium, lanthanum, europium, yttrium, and uranium.

In the embodiments shown in FIGS. 1A, 13A, 13B, and 17, a farm facility 211 which is used for the proposed system, comprises of a refinery and a treatment facility which are both used for further processes including the process of extracting specific chemical elements from produced crystallized salt and bittern which contain amounts of highly concentrated and specific chemical elements. The produced crystallized salt and bittern can be delivered by transport vessels 302 from the floating salt farm to the farm facility 211, in which the farm facility can be fixed on a station terminal 404.

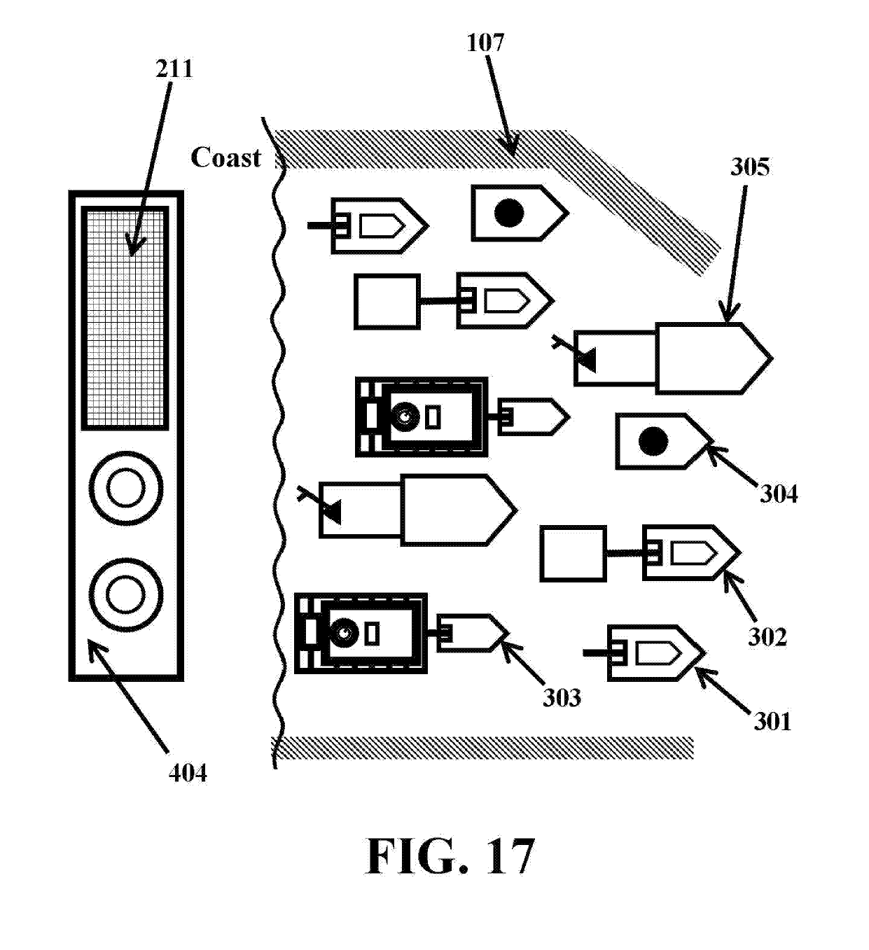

A station terminal 404 which is used for the proposed system, comprises of (a) an energy source facility, which is used for supplying energy sources to the floating salt farm and storing electric batteries used for the electricity storage tank 209, which the electricity storage tank 209 is mounted on the buoyant foundation 101, and (b) a drone platform facility which is used for launching and controlling aerial drones 306 and sea drones 307, as shown in FIGS. 13A, 13B, and 17.

At locations where higher stability may be needed, such as at locations with recurring inclement weather conditions, the station terminal 404 can be situated at a selected location, such as at a harbor with a breakwater 107, as shown in FIGS. 13A, 13B, and 17. A station terminal 404 equipped with a farm facility 211 is situated (a) at a specific onshore location, as shown in FIGS. 1A and 13A, or (b) at a specific offshore location where a station terminal 404 is fixed on the buoyant foundation 101, as shown in FIG. 13B.

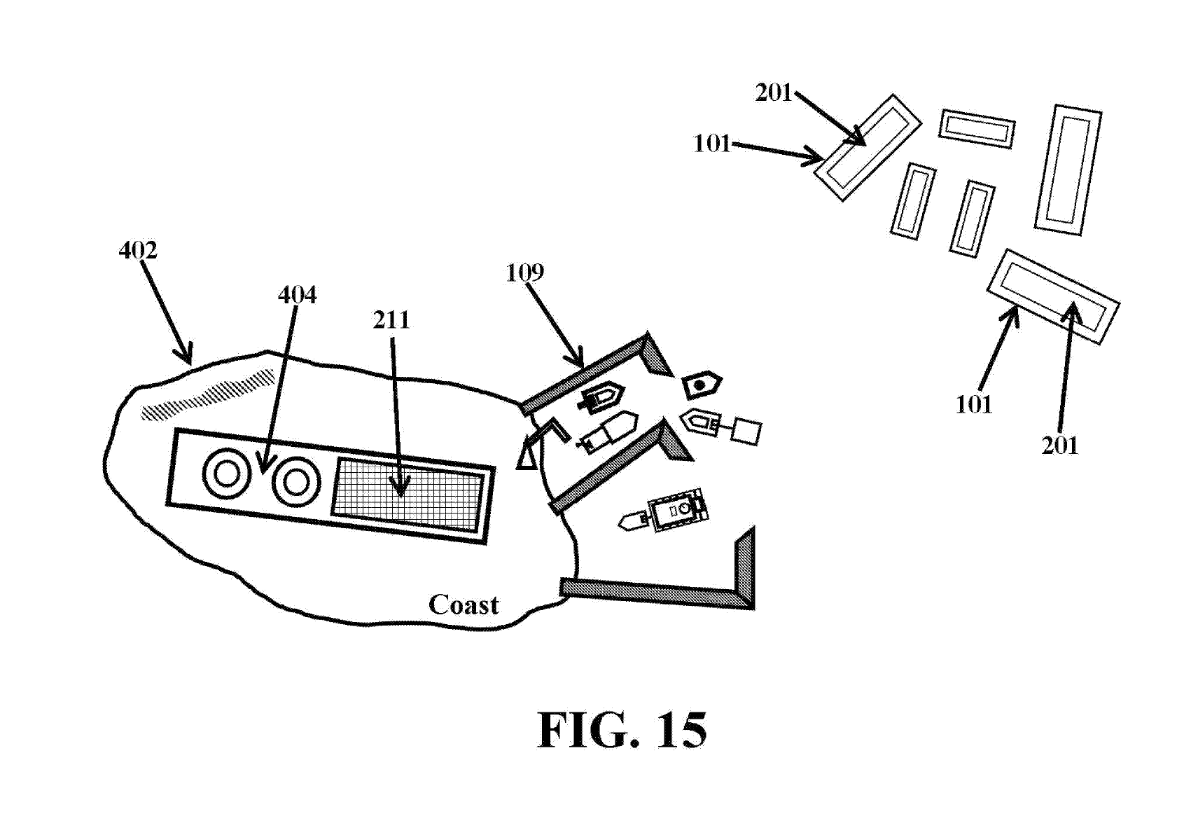

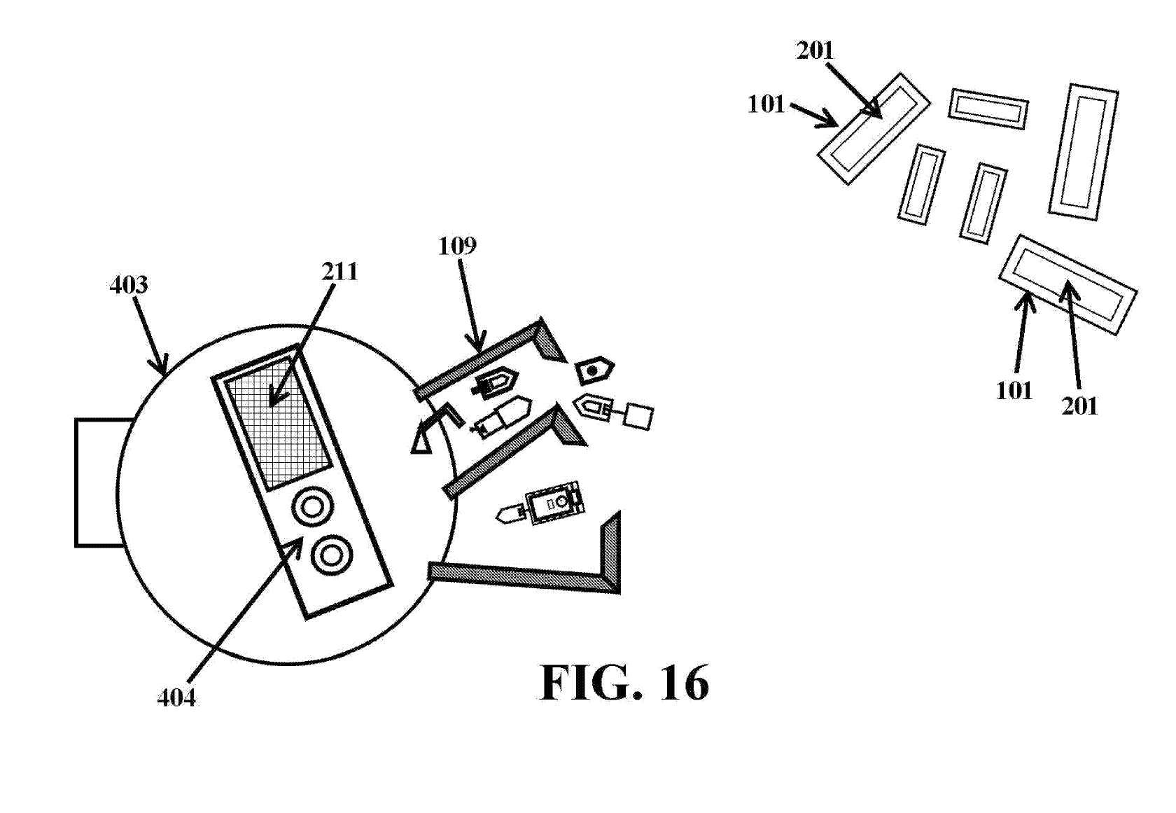

The farm facility 211 fixed on a station terminal 404 can be mounted on an island station terminal 402, as shown in FIG. 15, or on a floating station terminal 403, as shown in FIG. 16. The island station terminal 402 and/or the floating station terminal 403 are situated at specific offshore locations around sites of operating components 201, which are each fixed on the buoyant foundation 101, as shown in FIGS. 15 and 16.

If an island at a specific offshore location is in the vicinity of operating floating salt farms, the island can be refitted to be used as an island station terminal 402, as shown in FIG. 15.

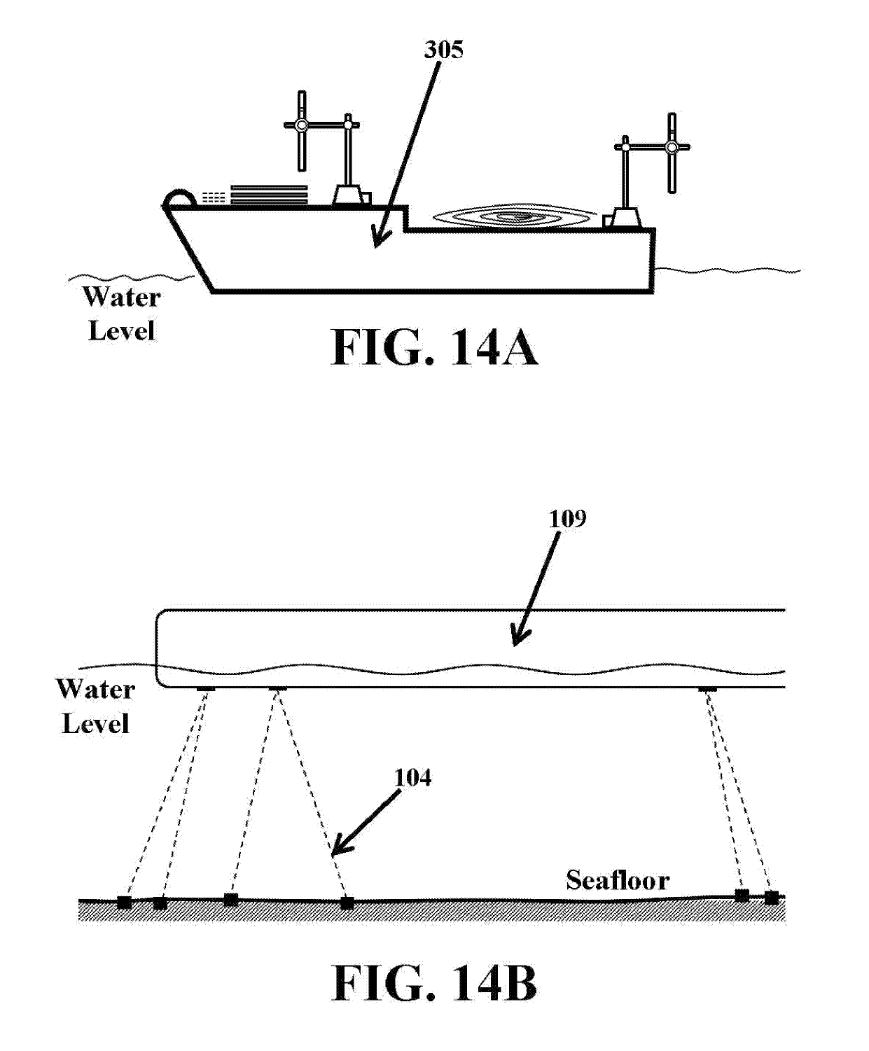

An island station terminal 402 and a floating station terminal 403 can be protected by a breakwater which can be a floating breakwater 109, as shown in FIG. 14B. The floating breakwater 109 can be reinforced with a mooring line structure 104 embedded to the seafloor, as shown in FIGS. 15 and 16.

In the embodiments shown in FIGS. 15, 16, and 17, the station terminal 404 can have a harbor with breakwater 107, which can be used for floating boats and stationed boats and vessels which are used for floating salt farm operations. The stationed boats and vessels include patrol boats 304, which can be used for patrolling the floating salt farm, as shown in FIG. 6, and repair vessels 305, as shown in FIG. 14A, which can be used for repairing the floating salt farm.

Drawing Reference Numerals

| | |
|---|---|
| 101 | Buoyant Foundation |
| 102 | Offshore Structure |
| 103 | Onshore Structure |
| 104 | Mooring Line Structure |
| 105 | Ballast Tank |
| 106 | Engine Device |
| 107 | Breakwater |
| 108 | Reflector |
| 109 | Floating Breakwater |
| 201 | Components |
| 202 | Photovoltaic Panels |
| 203 | Extraction Pipe Component |
| 204 | Extraction Pipe Fitting |
| 205 | Seawater Extraction Tube |
| 206 | Electric Cable |
| 207 | Motor Propeller |
| 208 | Lifter Device |
| 209 | Electricity Storage Tank |
| 210 | Offshore Fixed-Bottom Wind Turbine |
| 211 | Farm Facility |
| 212 | Seawater Tank |
| 301 | Towboat |
| 302 | Transport Vessel |
| 303 | Seawater Extraction Vessel |
| 304 | Patrol Boat |
| 305 | Repair Vessel |
| 306 | Aerial Drone |
| 307 | Sea Drone |
| 308 | Barge |
| 401 | Underwater Volcanic Vent |
| 402 | Island Station Terminal |
| 403 | Floating Station Terminal |
| 404 | Station Terminal |

What is claimed is:

1. A system situated at a specific offshore location for producing crystallized salt and bittern through evaporation by using extracted seawater containing amounts of specific chemical elements, the system comprising:
at least one buoyant foundation being situated on the surface of a body of seawater, said at least one buoyant foundation comprising:
at least one offshore structure or at least one onshore structure, connected to said at least one buoyant foundation for reinforcement; and
components being fixed on said at least one buoyant foundation, the components consisting essentially of:
at least one seawater tank for extracting the seawater; and
a plurality of photovoltaic panels for supplying electricity.

2. The system according to claim 1, wherein said at least one buoyant foundation further comprises at least one mooring line structure, said at least one mooring line structure being embedded to seafloor and being connected to said at least one buoyant foundation for reinforcing said at least one buoyant foundation.

3. The system according to claim 2, wherein said at least one mooring line structure is used with a combination of at least one offshore structure being connected to said at least one buoyant foundation for reinforcing said at least one buoyant foundation.

4. The system according to claim 1, wherein said at least one seawater tank fixed on said at least one buoyant foundation, extracts the seawater at the specific offshore location being around volcanic sites where the seawater is affected by volcanic eruption activities originating from at least one erupted underwater volcanic vent; and
wherein the seawater contains said amounts of specific chemical elements.

5. The system according to claim 1, further comprising at least one seawater extraction vessel connected to said at least one seawater tank for extracting the seawater, said at least one seawater extraction vessel being situated at the specific offshore location being around volcanic sites where the seawater is affected by volcanic eruption activities originating from at least one erupted underwater volcanic vent; and
wherein the seawater contains said amounts of specific chemical elements.

6. The system according to claim 1, wherein a said plurality of photovoltaic panels further comprises at least one electricity storage tank mounted on said at least one buoyant foundation, said at least one electricity storage tank being a storage structure for accumulating the electricity supplied from a said plurality of photovoltaic panels.

7. The system according to claim 6, wherein said electricity is capable of being supplied from at least one offshore fixed-bottom wind turbine, said at least one offshore fixed-bottom wind turbine being connected to said at least one electricity storage tank mounted on said at least one buoyant foundation.

8. The system according to claim 1, further comprising at least one farm facility fixed on at least one station terminal, said at least one farm facility being at least one refinery and at least one treatment facility for extracting said specific chemical elements from produced said crystallized salt and said bittern; and
wherein said produced crystallized salt and bittern contain said amounts of specific chemical elements.

9. The system according to claim 8, wherein said at least one station terminal is situated (a) at a specific onshore location, or (b) at a specific offshore location where said at least one station terminal being fixed on at least one buoyant foundation.

10. The system according to claim 1, wherein said at least one buoyant foundation further comprises at least one aerial drone and at least one sea drone, said at least one aerial drone and said at least one sea drone being patrolling devices for monitoring and measuring conditions for said at least one buoyant foundation and said components being fixed on said at least one buoyant foundation.

11. The system according to claim 1, wherein said at least one buoyant foundation (a) is a movable structure which comprises at least one barge with at least one motor propeller, or (b) is a fixed structure which comprises at least one offshore oil and gas platform being reinforced with at least one mooring line structure.
